(19) United States
(12) Patent Application Publication
(10) Pub. No.: US 2025/0190902 A1
(43) Pub. Date: Jun. 12, 2025

(54) INTELLIGENT SENTIMENT-BASED TICKET ALLOCATION/PROCESSING

(71) Applicant: Kyndryl, Inc., New York, NY (US)

(72) Inventors: Vinay Kumar Gajanana Hegde, Bangalore (IN); Omar Odibat, Cedar Park, TX (US); Balamukundan G. Iyer, CHENNAI (IN)

(21) Appl. No.: 18/533,688

(22) Filed: Dec. 8, 2023

(51) Int. Cl. G06Q 10/0631

(52) U.S. Cl. CPC G06Q 10/06315

(57) ABSTRACT

Embodiments input a plurality of data and a weightage reallocation to a dynamic ranking priority system, calculate a plurality of sentiment scores and a plurality of penalty scores based on the plurality of data, eliminate a sentiment score of the plurality of sentiment scores in response to a corresponding penalty score of the plurality of penalty scores being greater than a predetermined threshold, dynamically re-rank a plurality of tickets with a same priority using a machine learning (ML) model based on a type of the plurality of data which is most similar to historical data, dynamically change a pre-allocated weightage using a learn on the job (LOTJ) model based on a ticket resolution to perform based on the plurality of data, and adjust the weight reallocation based on the dynamically changed pre-allocated weightage.

### BACKGROUND

Aspects of the present invention relate generally to dynamic ranking of priority by correlation sentiment and business priorities and, more particularly, to system and method of intelligent sentiment-based ticket allocation/processing.

A service level agreement (SLA) is a known measure of core information technology (IT) services. An experience level agreement (XLA) is used to measure a service provided as part of a user experience that also gets reflected in a plurality of sentiments. In a system utilizing the SLA, action is prioritized based on severity associated with a plurality of tasks and a priority is based on a time of occurrence for the tasks.

### SUMMARY

In a first aspect of the invention, there is a computer-implemented method including: inputting, by a computing device, a plurality of data and a weightage reallocation to a dynamic ranking priority system; calculating, by the computing device, a plurality of sentiment scores and a plurality of penalty scores based on the plurality of data; eliminating, by the computing device, a sentiment score of the plurality of sentiment scores in response to a corresponding penalty score of the plurality of penalty scores being greater than a predetermined threshold; dynamically re-ranking, by the computing device, a plurality of tickets with a same priority using a machine learning (ML) model based on a type of the plurality of data which is most similar to historical data; dynamically changing, by the computing device, a pre-allocated weightage using a learn on the job (LOTJ) model based on a ticket resolution to perform based on the plurality of data; and adjusting, by the computing device, the weight reallocation based on the dynamically changed pre-allocated weightage.

In another aspect of the invention, there is a computer program product including one or more computer readable storage media having program instructions collectively stored on the one or more computer readable storage media. The program instructions are executable to: input a plurality of data and a weightage reallocation to a dynamic ranking priority system; calculate a plurality of sentiment scores and a plurality of penalty scores based on the plurality of data; eliminate a sentiment score of the plurality of sentiment scores in response to a corresponding penalty score of the plurality of penalty scores being greater than a predetermined threshold; dynamically re-rank a plurality of tickets with a same priority using a machine learning (ML) model based on a type of the plurality of data which is most similar to historical data; dynamically change a pre-allocated weightage using a learn on the job (LOTJ) model based on a ticket resolution to perform based on the plurality of data; and adjust the weight reallocation based on the dynamically changed pre-allocated weightage.

In another aspect of the invention, there is system including a processor, a computer readable memory, one or more computer readable storage media, and program instructions collectively stored on the one or more computer readable storage media. The program instructions are executable to: input a plurality of data and a weightage reallocation to a dynamic ranking priority system; calculate a plurality of sentiment scores and a plurality of penalty scores based on the plurality of data; eliminate a sentiment score of the plurality of sentiment scores in response to a corresponding penalty score of the plurality of penalty scores being greater than a predetermined threshold; dynamically re-rank a plurality of tickets with a same priority using a machine learning (ML) model based on a type of the plurality of data which is most similar to historical data; receive feedback from at least one of a support staff and a subject matter expert (SME) regarding the plurality of data; dynamically change a pre-allocated weightage using a learn on the job (LOTJ) model based on a ticket resolution to perform based on the plurality of data and the feedback from the at least one of the support staff and the SME; and adjust the weight reallocation based on the dynamically changed pre-allocated weightage.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of a dynamic ranking priority system in accordance with aspects of the present invention.

FIG. 5 shows a flowchart of the dynamic ranking priority system in accordance with aspects of the present invention.

FIG. 6 shows a block diagram of ranking priorities in the dynamic ranking priority system in accordance with aspects of the present invention.

FIG. 7 shows another block diagram of a dynamic ranking priority system in accordance with aspects of the present invention.

FIG. 8 shows another flowchart of the dynamic ranking priority system in accordance with aspects of the present invention.

### DETAILED DESCRIPTION

Aspects of the present invention relate generally to dynamic ranking of priority by correlation sentiment and business priorities. In more specific embodiments, aspects of the present invention related to systems and methods of intelligent sentiment-based ticket allocation/processing. According to aspects of the invention, priority of tickets are realistic and reflect formal and tangible weightings of emotions and sentiments (hereinafter referred to as “sentiment”) with business priorities. Embodiments of the present invention help support staff to directly act on a plurality of tickets by eliminating a ticket allocation process. In particular, embodiments provide automation of ticket allocation which eliminates a queue coordinator role and saves costs to an organization. In embodiments, a dynamic ranking priority system uses an algorithm to rank tickets by incorporating sentiments to dynamically focus on a priority while eliminating any artificial sentiments. Embodiments of the present invention drive selection of tickets within a same rank, category, and bucket by using user sentiments and business priorities and avoiding pre-defined rigid rankings. In this manner, implementations of the invention save costs by using flexible ticket selection based on sentiments and business priorities. Embodiments of the present invention provide ticket selections based on sentiments and business priorities to help a service agent to address the ticket and avoid ticket selection based on time bound priorities within a same rank and category. Embodiments of the present invention prioritize tickets by avoiding human bias in ticket selection. In further embodiments, the dynamic ranking priority system which ranks a sentiment in priority order.

Embodiments of the present invention capture a plurality of sentiments and dynamically prioritize multiple tickets that have a same ranking within a dynamic ranking priority system. Embodiments of the present invention capture the plurality of sentiments across a plurality of channels and evaluate the plurality of sentiments as a function of the dynamic ranking priority system. Further, embodiments of the present invention continuously learns and improves the dynamic ranking priority system through a learning on the job (LOTJ) model. Embodiments of the present invention also provide penalty scores to track abuse of the dynamic ranking priority system based on the plurality of sentiments. Embodiments of the present invention nullify artificial emotions or sentiments by using a natural language library to consider who, why, where, what, when, and how factors occur before determining a priority ranking. Embodiments of the present invention use a list of highest priority types which qualify for a highest priority ranking, and determine that the rest of the data have a secondary priority ranking in response to the list of highest priority types being input to the dynamic ranking priority system.

Embodiments of the present invention dynamically re-rank tickets with a same priority and ranking by measuring an urgency of the tickets and measuring a plurality of sentiments of a user using a dynamic ranking priority system. Embodiments of the present invention re-rank tickets with the same priority and ranking based on live conditions of data from a plurality of channels. Embodiments of the present invention perform dynamic re-ranking of priorities based on the plurality of sentiments and perform dynamic re-ranking based on a learning on the job (LOTJ) model using inputs from support services staff and subject matter experts (SMEs) and changed weightings of multiple data segments. Embodiments of the present invention also incorporate a list of the highest priority types which have top priorities, such as tickets related to a down center being down, an application being down, no network connectivity, etc. Embodiments of the present dynamically re-rank a priority of tickets based on business priorities and the plurality of sentiments and provide tangible value to the sentiments blended with impact and urgency. Embodiments of the present invention nullify artificial sentiments based on a correlation between historical data and conditions of data segments and categorization.

According to an aspect of the invention, the system, method, and computer program product dynamically ranks a set of tasks with a same priority. For example, the computer-implemented method includes: receiving, from a plurality of phases of a helpdesk ticketing system, a set of inputs associated with the plurality of phases and a set of tasks; calculating, for at least a portion of the set of inputs, a plurality of sentiment scores; balancing a set of business priorities against the plurality of sentiment scores; adjusting the balanced sentiment scores according to a set of feedback; re-ranking the set of tasks according to the adjusted balanced sentiment scores; and resolving the set of tasks according to the re-ranking. The computer-implemented method also includes logging a set of parameters which describe the balancing and the adjusting of the sentiment scores for use in future calculations of sentiment score sets. The computer-implemented method also includes concurrently performing the calculating, the balancing, and the adjusting and dynamically providing a real-time re-ranking of the set of tasks as the set of inputs are received. The computer-implemented method also includes the balancing including a set of static, non-alterable priority characteristics for system-critical tasks.

Implementations of the present invention provide an improvement in the technical field of ticket selection by utilizing a dynamic ranking priority system which includes a plurality of sentiments from various segments of users and incorporates the plurality of sentiments to dynamically drive rankings and priorities as part of a ticket fulfillment process. Embodiments of the present invention utilize the dynamic ranking priority system to blend the plurality of sentiments with business priorities without affecting a list of the highest priority types, which are tickets designated as a high priority. In particular, the plurality of sentiments of users may include user satisfaction scores, user experiences, feedback systems, primary research segments, secondary research segments, etc. In embodiments, the dynamic ranking priority system incorporates the plurality of sentiments in an overall ranking of tickets. Embodiments of the present invention also utilize a learning on the job (LOTJ) model to provide continuous learning and improved accuracy of the dynamic ranking priority system. In contrast, known systems prioritize tickets based on when the tickets are received (i.e., the prioritization is time bound) and doesn't include any sentiments from users. In known systems, sentiments are merely included in feedback forums or research and are added as comments to tickets. However, known systems do not incorporate the sentiments within service level agreements (SLA) and do not use sentiments to re-rank priorities or rankings of tickets.

Implementations of the present invention are necessarily rooted in computer technology. For example, the step of training the LOTJ model to improve accuracy of ticket selection is computer-based and cannot be performed in the human mind. Training and building the LOTJ model is, by definition, performed by a computer and cannot practically be performed in the human mind (or with pen and paper) due to the complexity and massive amounts of calculations involved. For example, training and building the LOTJ model in embodiments of the present invention may use machine learning to build and train the LOTJ model using feedback data to improve accuracy of ticket selection. In particular, training and building the LOTJ model performs a large among of processing of the feedback data and modeling of parameters to train the LOTJ model such that the LOTJ model generates and outputs in real time (or near real time). In other words, the LOTJ model is trained using a large amount of previously captured ticket data, feedback data, user data, and business data, and other parameters such that the LOTJ model is configured to output allocated weightings of tickets in real-time. Given the scale and complexity of processing captured ticket data, feedback data, user data, and business data and modeling of parameters, it is simply not possible for the human mind, or for a person using pen and paper, to perform the number of calculations involved in training and/or building the LOTJ model.

It should be understood that, to the extent implementations of the invention collect, store, or employ personal information provided by, or obtained from, individuals (for example, users of the dynamic ranking priority system), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (Saas): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

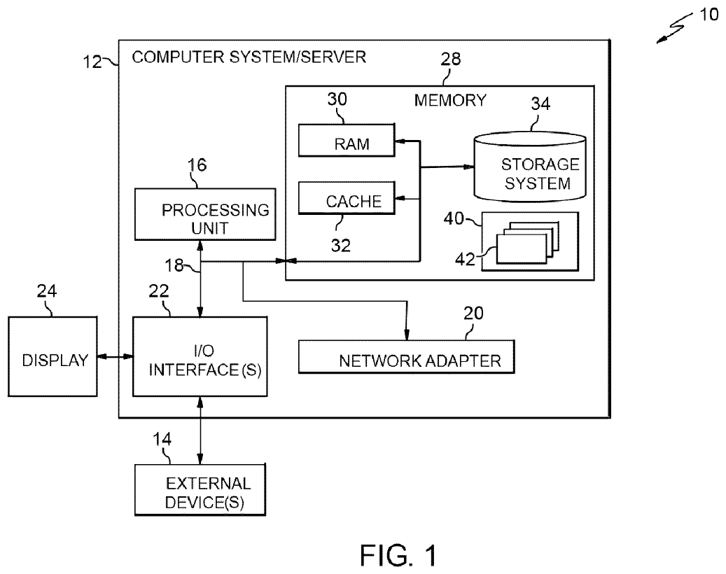

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

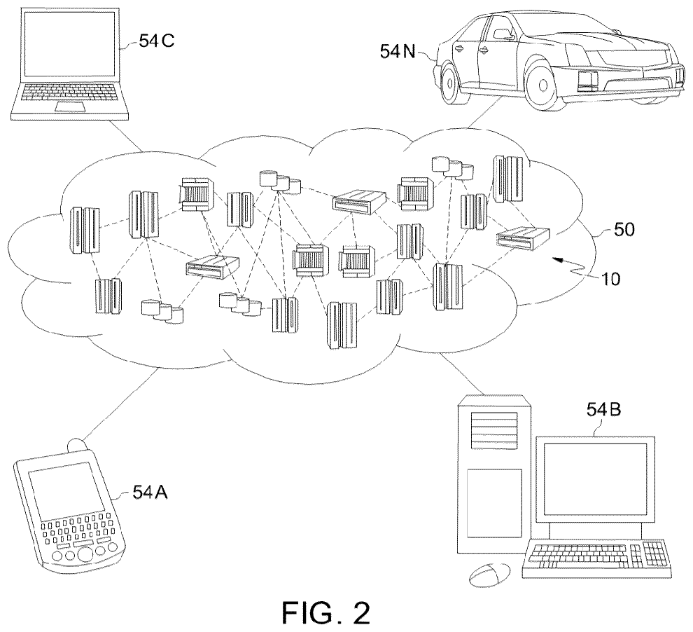

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

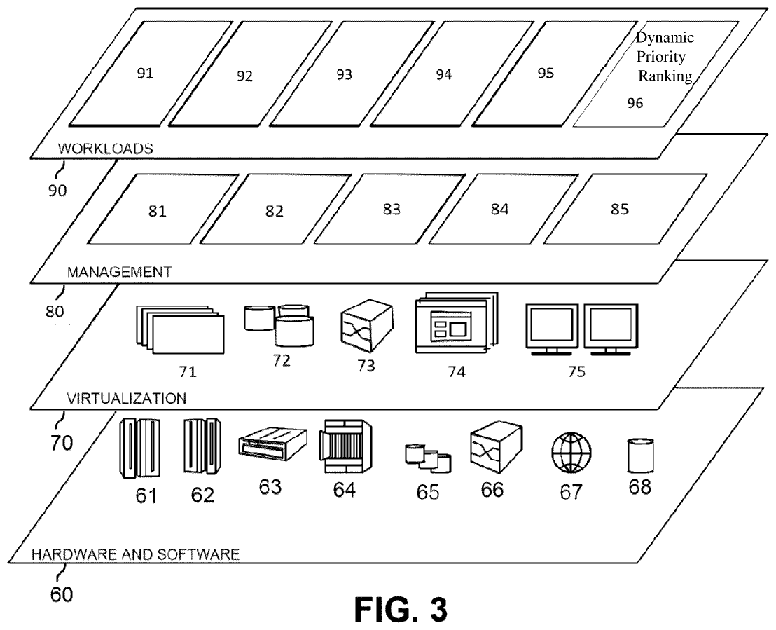

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and dynamic ranking priority 96.

Implementations of the invention may include a computer system/server 12 of FIG. 1 in which one or more of the program modules 42 are configured to perform (or cause the computer system/server 12 to perform) one of more functions of the dynamic ranking priority 96 of FIG. 3. For example, the one or more of the program modules 42 may be configured to: receive from a plurality of phases of a helpdesk ticketing system, a set of inputs associated with the plurality of phases and a set of tasks; calculate, for at least a portion of the set of inputs, a plurality of sentiment scores; balance a set of business priorities against the plurality of sentiment scores; adjust the balanced sentiment scores according to a set of feedback; re-rank the set of tasks according to the adjusted balanced sentiment scores; and resolve the set of tasks according to the re-ranking.

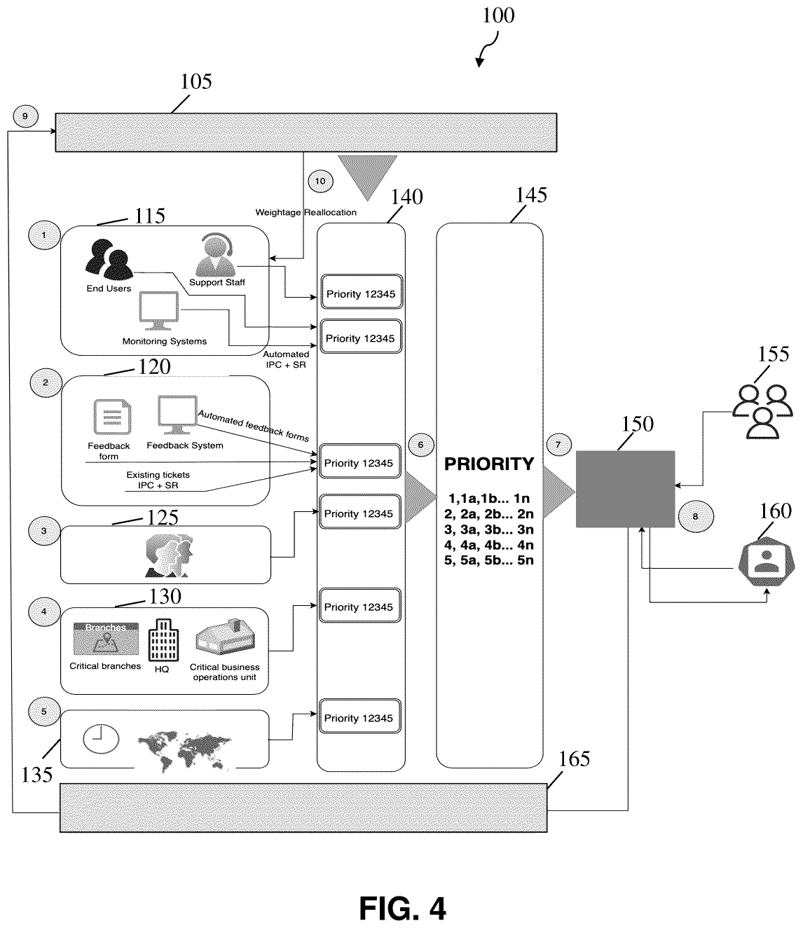

FIG. 4 shows a block diagram of a dynamic ranking priority system in accordance with aspects of the invention. In embodiments, the dynamic ranking priority system 100 comprises a dynamic weight allocator 105, at least one live channel 115, at least one secondary channel 120, at least one persona 125, at least one location 130, at least one time zone 135, a status change device 140, a support service device 145, an action device 150, at least one operating environment 155, at least one subject matter expert (SME) 160, and a learning on the job (LOTJ) model 165, each of which may comprise one or more program modules such as program modules 42 described with respect to FIG. 1. The dynamic ranking priority system 100 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In embodiments of FIG. 4, the at least one live channel 115, the at least one secondary channel 120, the at least on persona 125, the at least one location 130, and the at least one time zone 135 of the dynamic ranking priority system 100 captures data corresponding to a plurality of sentiments and business impacts and sends the data corresponding to the plurality of sentiments and business impacts to the status change device 140. In further embodiments, a dynamic ranking priority system comprises the at least one live channel 115, the at least one secondary channel 120, the at least on persona 125, the at least one location 130, and the at least one time zone 135 for capturing the data corresponding to the plurality of sentiments and business impacts. The at least one live channel 115 may include a plurality of end users which contact a support help desk, support staff which create live tickets, and a plurality of monitoring systems which perform live monitoring of a system to generate live logs, live events, live video, live audio, and live text which is sent to the status change device 140. In embodiments, the plurality of monitoring systems sends automated incident, problem, and change (IPC) tickets and service request (SR) tickets to the status change device 140. The at least one live channel 115 may also receive a weightage reallocation from the dynamic weight allocator 105 and send the weightage reallocation to the status change device 140.

In embodiments of FIG. 4, the at least one secondary channel 120 may include a feedback form, a feedback system, and existing tickets which contain feedback written by support staff on behalf of a requester. In embodiments, the feedback system may include at least one of an application, a browser, etc., for providing automated feedback forms to the status change device 140. In further embodiments, the existing tickets comprises IPC tickets and SR tickets which are sent to the status change device 140.

In embodiments of FIG. 4, the at least one persona 125 may include a plurality of personas and a corresponding importance in an organization based on a business department, whether the plurality of personas are part of the at least one live channel 115, and whether the plurality of personas are part of the at least one secondary channel 120. In embodiments, the plurality of personas may include a persona location which is used to determine the importance to the organization and a time that a persona contacts the status change device 140. In embodiments, persona data (e.g., the business department, the persona location, the time that the persona contacts the dynamic ranking priority system, whether a persona is part of the at least one live channel 115 or the at least one secondary channel 120) related to the at least one persona 125 is sent to the status change device 140 along with appropriate weightage which depends on the importance of the persona to the organization.

In embodiments of FIG. 4, the at least one location 130 may include a critical branch of the organization, headquarters of the organization, and a critical business operations unit of the organization. In embodiments, the at least one location 130 is critical for employees of the organization and customers based on a corresponding value to the organization and presence in a location. In embodiments, the at least one location 130 is sent to the status change device 140 along with an appropriate weightage which depends on the importance of a location to the organization. In embodiments, the appropriate weightage is used for redistribution of a dynamic ranking within a same priority.

In embodiments of FIG. 4, the at least one time zone 135 comprises a time zone at which a user contacts the dynamic ranking priority system. In embodiments, the at least one time zone 135 plays an important and crucial role in determining emotions that contributes to the plurality of sentiments. For example, in response to the user contacting the dynamic ranking priority system during non-working hours, a high weightage is given in comparison to a situation where the user contacts the dynamic ranking priority system during working hours. The at least one time zone 135 and the appropriate weightage is sent to the status change device 140.

In embodiments of FIG. 4, the status change device 140 receives data from the at least one live channel 115, the at least one secondary channel 120, the at least one persona 125, the at least one location 130, and the at least one time zone 135 and appropriate weightings corresponding to the data. The status change device 140 also receives the weightage reallocation from the at least one live channel 115. The status change device 140 orders the received data based on the appropriate weightings corresponding to the data and the weightage reallocation and allocates a priority to the received data. The status change device 140 then sends the received data with the allocated priority to the support service device 145.

In embodiments of FIG. 4, the support service device 145 receives the data with the allocated priority from the status change device 140. The support service device 145 balances business priorities and a plurality of sentiments by using a machine learning (ML) model to dynamically re-rank tickets with a same priority based on a type of the received data. In embodiments, the type of the received data may comprise an IPC ticket or an SR ticket. In an example, the ML model may dynamically re-rank tickets with the same priority based on a previous ranking of historical data which is most similar to the type of the received data. In a non-limiting example, the support service device 145 may receive an existing computing device error from an end user, and the ML model dynamically re-ranks the existing computing device error based on the previous ranking of similar historical computing device errors. In further embodiments, the ML model of the support service device 145 comprises a random forest model which combines multiple decision trees to provide an accurate prediction. In another example, the ML model of the support service device 145 comprises a linear regression model which computes a linear relationship between a dependent variable and one or more independent features to output an accurate predication. However, embodiments of the present invention are not limited to these models, and may use different machine learning (ML) models depending on the type of data received. The ML model of the support service device 145 is trained using historical tickets to provide a more accurate prediction for dynamically re-ranking tickets with the same priority. The support service device 145 then sends the re-ranked tickets with the same priority and remaining data with the allocated priority to the action device 150.

In embodiments of FIG. 4, the action device 150 handles the re-ranked tickets with the same priority and remaining data with the allocated priority such that at least one operating environment 155 provides appropriate actions to perform (e.g., resolve tickets) based on data corresponding to the IPC tickets and SR tickets. In addition, the action device 150 receives feedback from the at least one operating environment 155 and the at least one subject matter expert (SME) 160 regarding whether priority needs to be changed for future tickets. The action device 150 then sends the feedback from the at least one operating environment 155 and the at least one SME 160 to the LOTJ model 165. In embodiments, at least one support staff of an organization may utilize the at least one operating environment 155 as an example.

In embodiments of FIG. 4, the LOTJ model 165 uses the feedback from the at least one operating environment 155 and the at least one SME 160 to the LOTJ model 165 to dynamically change a pre-allocated weightage for future tickets and future data. The LOTJ model 165 may also use the appropriate actions to perform based on the data corresponding to the IPC tickets and SR tickets to dynamically change the pre-allocated weightage for future tickets and future data. In embodiments, the LOTJ model 165 is a machine learning (ML) model which continuously learns and improves the pre-allocated weightage for future tickets and future data based on feedback from the at least one operating environment 155 and the at least one SME 160 and appropriate actions to perform based on the data corresponding to the IPC tickets and SR tickets. The LOTJ model 165 then sends the pre-allocated weightage for future tickets and future data to the dynamic weight allocator 105. The dynamic weight allocator 105 will then provide an adjusted weightage reallocation to the at least one live channel 115 based on the received pre-allocated weightage for future tickets and future data.

In embodiments of FIG. 4, the dynamic ranking priority system 100 calculates artificial sentiments and penalty scores. In particular, the dynamic ranking priority system 100 calculates the artificial sentiments based on a sentiment score to decide the artificialness of a sentiment. In particular, the dynamic ranking priority system 100 calculates the sentiment score based on at least one of a technical identification of a user (e.g., password, dual authentication, etc.), a biological identification of the user (e.g., eye, retina, face recognition, fingerprint, etc.), historical data (e.g., feedback pattern matching), and natural language processing (e.g., error words, gap words, wrongly spelled words, short sentence with repetition, short sentence with verbal errors, etc.)

In embodiments of FIG. 4, the dynamic ranking priority system 100 also keeps track of users who abuse a system by adding a penalty score to the sentiment score. In embodiments, in response to the penalty score being larger than the sentiment score, the sentiment score may be eliminated from the dynamic ranking priority system 100. In other embodiments, in response to the penalty score being greater than a predetermined threshold, the sentiment score may be eliminated from the dynamic ranking priority system 100. In embodiments, the dynamic ranking priority system 100 determines a magnitude of a penalty score based on how far a current sentiment score is from a plurality of sentiment scores of all tickets belonging to a same priority as the current ticket and how many times a user has abused the system in the past. In embodiments, in response to the user abusing the system in the past, any tickets from that user can be given a higher, or lower, priority in the future. In further embodiments, in response to the user abusing the system in the past, any tickets from that user can be evaluated by at least one of the at least one operating environment 155 and the at least one SME 160. In further embodiments, the status change device 140 calculates the sentiment score, the artificial sentiments, and the penalty score. However, embodiments are not limited, and these scores and sentiments can be calculated by other modules of the dynamic ranking priority system 100.

In embodiments of FIG. 4, the dynamic ranking priority system 100 may also create a list of the highest priority types which are stored in a database. The dynamic ranking priority system 100 may create the list of the highest priority types based on historical tickets which are given a highest priority. For example, the list of highest priority types may include data center on fire within a region of the dynamic ranking priority system, earthquake, power outage within the region of the dynamic ranking priority system, data center being down, an application is down, no network connectivity, etc., which are tickets that are given the highest priority based on the impact of these tickets on the organization and business priorities.

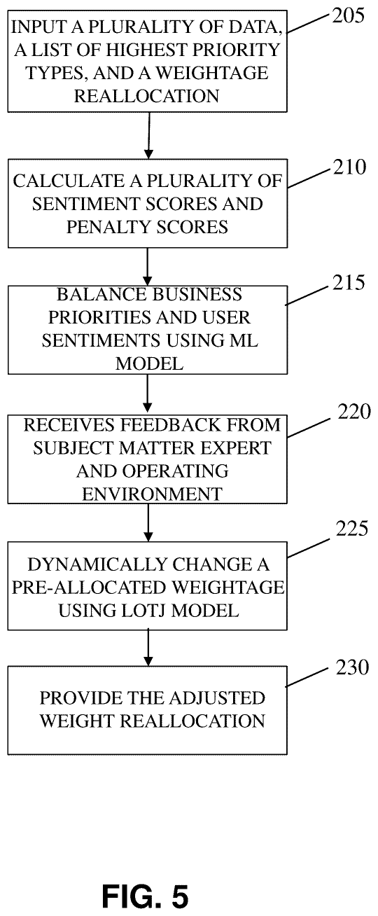

FIG. 5 shows a flowchart of an exemplary method in accordance with aspects of the present invention. Steps of the method may be carried out in the environment of FIG. 4 and are described with reference to elements depicted in FIG. 4.

At step 205, the system inputs, at the status change device 140, a plurality of data, a list of the highest priority types, and a weightage allocation. In embodiments, and as described with respect to FIG. 4, the plurality of data is input from the at least one live channel 115, the at least one secondary channel 120, the at least one persona 125, the at least one location 130, and the at least one time zone 135 and appropriate weightings corresponding to the plurality of data. In further embodiments, the weightage allocation is received from the at least one live channel 115 and the list of the highest priority types is received from a database which stores the list of the highest priority types.

At step 210, the system calculates, at the status change device 140, a plurality of sentiment scores and penalty scores. In embodiments, and as described with respect to FIG. 4, in response to the penalty score being greater than a predetermined threshold, the sentiment score may be eliminated from the dynamic ranking priority system 100. In further embodiments, the status change device 140 sends the received data with the allocated priority to the support service device 145

At step 215, the system balances, at the support service device 145, business priorities and a plurality of sentiments by using a machine learning (ML) model to dynamically re-rank tickets with a same priority based on a type of the received data. In embodiments, and as described with respect to FIG. 4, the ML model of the support service device 145 is trained using historical tickets to provide a more accurate prediction for dynamically re-ranking tickets with the same priority.

At step 220, the system receives, at the action device 150, feedback from the at least one operating environment 155 and the at least one subject matter expert (SME) 160 regarding whether priority needs to be changed for future tickets. In embodiments, and as described with respect to FIG. 4, the action device 150 then sends the feedback from the at least one operating environment 155 and the at least one SME 160 to the LOTJ model 165.

At step 225, the system dynamically changes, at the LOTJ model 160, a pre-allocated weightage based on the feedback from the action device 150. In embodiments, and as described with respect to FIG. 4, the LOTJ model also uses appropriate actions to perform based on the data corresponding to the IPC tickets and SR tickets to dynamically change the pre-allocated weightage. In further embodiments, the LOTJ model then sends the pre-allocated weightage to the dynamic weight allocator 105. At step 230, the system provides, at the dynamic weight allocator 105, an adjusted weightage reallocation to the at least one live channel 115 based on the received pre-allocated weightage.

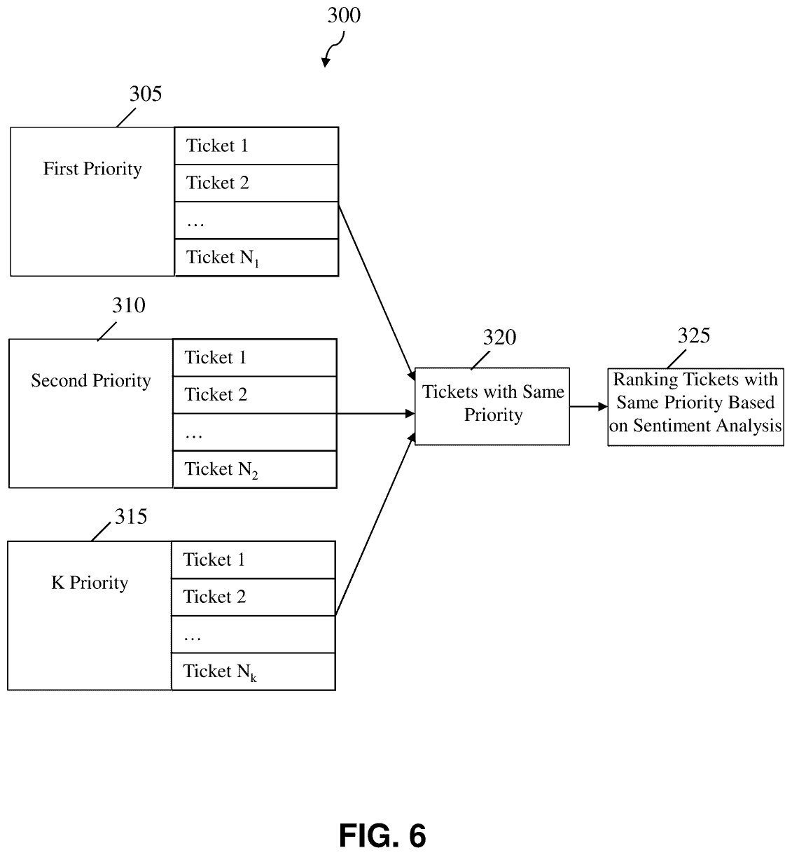

FIG. 6 shows a block diagram of ranking priorities in the dynamic ranking priority system in accordance with aspects of the present invention. In particular, the diagram 300 of ranking priorities in the dynamic ranking priority system 100 comprises a first priority 305 with a plurality of tickets (e.g., ticket 1, ticket 2, . . . , ticket N₁), a second priority 310 with another plurality of tickets (e.g., ticket 1, ticket 2, . . . , ticket N₂), and a K priority 315 with another plurality of tickets (e.g., ticket 1, ticket 2, . . . , ticket Nₖ). In embodiments, the first priority 305, the second priority 310, and the K priority 315 may be based on business priorities. Further, at block 320, tickets are received with a same priority. For example, at block 320, ticket 1, ticket 2, . . . , ticket N₁ all have a same first priority. These tickets are then sent to block 325 which dynamically re-ranks the tickets with the same priority based on a plurality of sentiment analyses of a user. For example, ticket N₁ may be ranked ahead of ticket 2 and ticket 2 may be ranked ahead of ticket 1 based on the plurality of sentiment analyses for the first priority 305. Thus, the dynamic ranking priority system 100 balances the business priorities with the sentiment analyses to improve the ranking of tickets. In contrast, known methods simply re-rank tickets with the same priority based on when they are received in a queue (i.e., a timestamp of when the tickets are received within the queue). Thus, known methods do not provide a dynamic re-ranking of tickets within a same priority based on a plurality of sentiments of a user.

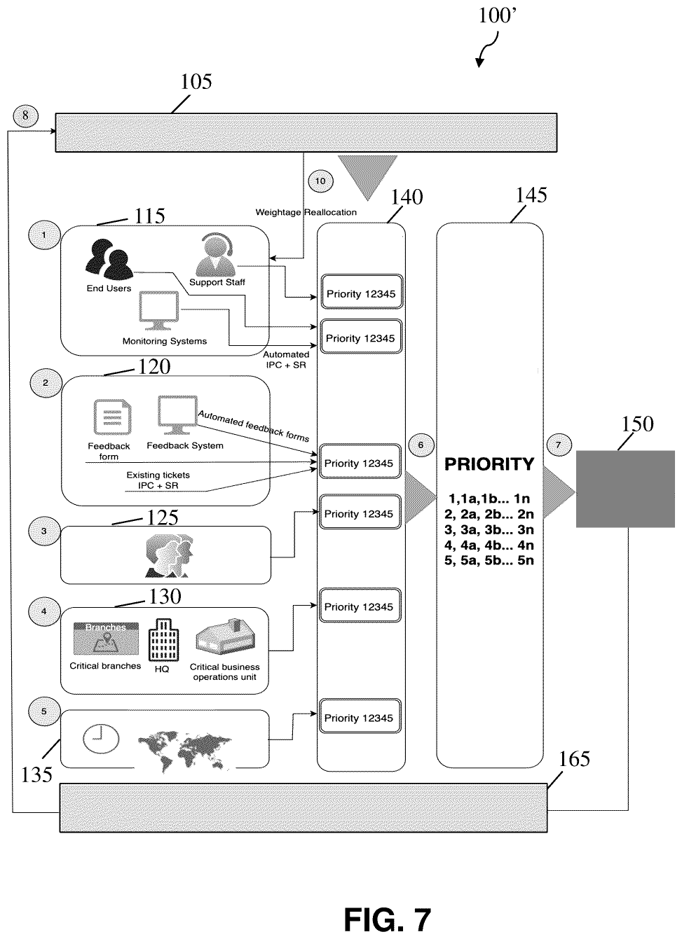

FIG. 7 shows another block diagram of a dynamic ranking priority system in accordance with aspects of the present invention. In FIG. 7, the dynamic ranking priority system 100′ is similar to the dynamic ranking priority system in FIG. 4 with the exception of the action device 150 not receiving feedback from the at least one operating environment 155 and the at least one subject matter expert (SME) 160. Thus, in FIG. 7, the LOTJ model 165 receives the appropriate actions to perform from the action device 150 and dynamically changes the pre-allocated weightage for future tickets and future data based on only on the data corresponding to the IPC tickets and SR tickets. In embodiments, the LOTJ model 165 is a machine learning (ML) model which continuously learns and improves the pre-allocated weightage for future tickets and future data based on the appropriate actions to perform based on the data corresponding to the IPC tickets and SR tickets. Thus, in FIG. 7, the dynamic ranking priority system 100′ may be a truly automated system which does not require feedback from the at least one operating environment 155 or at least one SME 160.

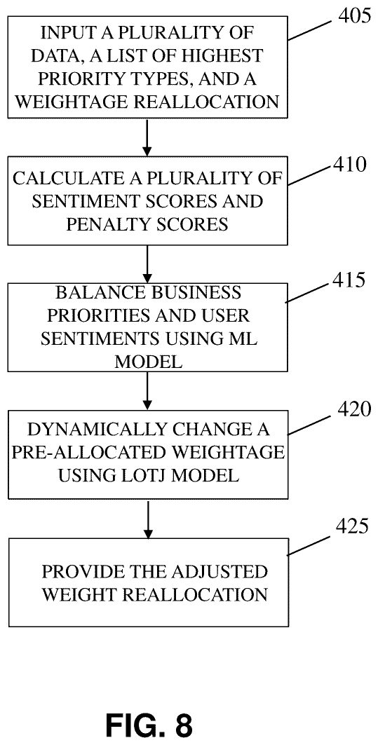

FIG. 8 shows a flowchart of an exemplary method in accordance with aspects of the present invention. Steps of the method may be carried out in the environment of FIG. 7 and are described with reference to elements depicted in FIG. 7.

At step 405, the system inputs, at the status change device 140, a plurality of data, a list of the highest priority types, and a weightage allocation. In embodiments, and as described with respect to FIG. 7, the plurality of data is input from the at least one live channel 115, the at least one secondary channel 120, the at least one persona 125, the at least one location 130, and the at least one time zone 135 and appropriate weightings corresponding to the plurality of data. In further embodiments, the weightage allocation is received from the at least one live channel 115 and the list of the highest priority types is received from a database which stores the list of the highest priority types.

At step 410, the system calculates, at the status change device 140, a plurality of sentiment scores and penalty scores. In embodiments, and as described with respect to FIG. 7, in response to the penalty score being greater than a predetermined threshold, the sentiment score may be eliminated from the dynamic ranking priority system 100. In further embodiments, the status change device 140 sends the received data with the allocated priority to the support service device 145

At step 415, the system balances, at the support service device 145, business priorities and a plurality of sentiments by using a machine learning (ML) model to dynamically re-rank tickets with a same priority based on a type of the received data. In embodiments, and as described with respect to FIG. 7, the ML model of the support service device 145 is trained using historical tickets to provide a more accurate prediction for dynamically re-ranking tickets with the same priority.

At step 420, the system dynamically changes, at the LOTJ model 160, a pre-allocated weightage based on the appropriate actions to perform based on the data corresponding to the IPC tickets and SR tickets. In further embodiments, the LOTJ model then sends the pre-allocated weightage to the dynamic weight allocator 105. At step 425, the system provides, at the dynamic weight allocator 105, an adjusted weightage reallocation to the at least one live channel 115 based on the received pre-allocated weightage.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
inputting, by a computing device, a plurality of data and a weightage reallocation to a dynamic ranking priority system;
calculating, by the computing device, a plurality of sentiment scores and a plurality of penalty scores based on the plurality of data;
eliminating, by the computing device, a sentiment score of the plurality of sentiment scores in response to a corresponding penalty score of the plurality of penalty scores being greater than a predetermined threshold;
dynamically re-ranking, by the computing device, a plurality of tickets with a same priority using a machine learning (ML) model based on a type of the plurality of data which is most similar to historical data;
dynamically changing, by the computing device, a pre-allocated weightage using a learn on the job (LOTJ) model based on a ticket resolution to perform based on the plurality of data; and
adjusting, by the computing device, the weight reallocation based on the dynamically changed pre-allocated weightage.

2. The method of claim 1, further comprising inputting a list of highest priority types which have a high priority based on an impact on an organization which corresponds with the plurality of data.

3. The method of claim 2, wherein the list of highest priority types comprises a power outage within a region of the dynamic ranking priority system

4. The method of claim 2, wherein the list of highest priority types comprises a data center being on fire within a region of the dynamic ranking priority system.

5. The method of claim 1, wherein the ML model is a random forest model which combines multiple decision trees to provide dynamic re-ranking of the plurality of tickets with the same priority.

6. The method of claim 1, wherein the ML model is a linear regression model which computes a linear relationship between a dependent variable and one or more independent features to output a dynamic re-ranking of the plurality of tickets with the same priority.

7. The method of claim 1, further comprising performing the ticket resolution based on the type of the plurality of data.

8. The method of claim 7, wherein the type of the plurality of data comprises incident, problem, and change (IPC) tickets.

9. The method of claim 1, further comprising receiving feedback from at least one of a support staff or a subject matter expert (SME) regarding the plurality of data.

10. The method of claim 9, wherein the dynamically changing the pre-allocated weightage using the LOTJ model is further based on the feedback from at least one of the support staff or the SME.

11. The method of claim 1, further comprising determining a magnitude of the penalty score based on a number of times a user has abused the dynamic ranking priority system in the past.

12. A computer program product comprising one or more computer readable storage media having program instructions collectively stored on the one or more computer readable storage media, the program instructions executable to:
input a plurality of data and a weightage reallocation to a dynamic ranking priority system;
calculate a plurality of sentiment scores and a plurality of penalty scores based on the plurality of data;
eliminate a sentiment score of the plurality of sentiment scores in response to a corresponding penalty score of the plurality of penalty scores being greater than a predetermined threshold;
dynamically re-rank a plurality of tickets with a same priority using a machine learning (ML) model based on a type of the plurality of data which is most similar to historical data;
dynamically change a pre-allocated weightage using a learn on the job (LOTJ) model based on a ticket resolution to perform based on the plurality of data; and
adjust the weight reallocation based on the dynamically changed pre-allocated weightage.

13. The computer program product of claim 12, wherein the ML model is a random forest model which combines multiple decision trees for dynamic re-ranking of the plurality of tickets with the same priority.

14. The computer program product of claim 12, wherein the ML model is a linear regression model which computes a linear relationship between a dependent variable and one or more independent features to output a dynamic re-ranking of the plurality of tickets with the same priority.

15. The computer program product of claim 12, further comprising performing the ticket resolution based on the type of the plurality of data.

16. The computer program product of claim 15, wherein the type of the plurality of data comprises service request (SR) tickets.

17. The computer program product of claim 12, further comprising receiving feedback from at least one of a support staff and a subject matter expert (SME) regarding the plurality of data.

18. The computer program product of claim 17, wherein the dynamically changing the pre-allocated weightage using the LOTJ model is further based on the feedback from at least one of the support staff and the SME.

19. The computer program product of claim 12, further comprising determining a magnitude of a penalty score based on a number of times a user has abused the dynamic ranking priority system in the past.

20. A system comprising:
a processor, a computer readable memory, one or more computer readable storage media, and program instructions collectively stored on the one or more computer readable storage media, the program instructions executable to:
input a plurality of data and a weightage reallocation to a dynamic ranking priority system;
calculate a plurality of sentiment scores and a plurality of penalty scores based on the plurality of data;
eliminate a sentiment score of the plurality of sentiment scores in response to a corresponding penalty score of the plurality of penalty scores being greater than a predetermined threshold;
dynamically re-rank a plurality of tickets with a same priority using a machine learning (ML) model based on a type of the plurality of data which is most similar to historical data;
receive feedback from at least one of a support staff and a subject matter expert (SME) regarding the plurality of data;
dynamically change a pre-allocated weightage using a learn on the job (LOTJ) model based on a ticket resolution to perform based on the plurality of data and the feedback from the at least one of the support staff and the SME; and
adjust the weight reallocation based on the dynamically changed pre-allocated weightage.
